(19) United States
(12) Patent Application Publication
(10) Pub. No.: US 2008/0267015 A1
(43) Pub. Date: Oct. 30, 2008

(54) ELECTRONIC DEVICE AND AUTOMATIC TURNOFF METHOD FOR THE SAME

(75) Inventors: NA ZHANG, Shenzhen (CN); XIN LU, Shenzhen (CN); BI-QING LUO, Shenzhen (CN); XUE-SHUN LIU, Shenzhen (CN); BIAO-GENG ZHONG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Taipei Hsien (TW)

(21) Appl. No.: 11/938,305

(22) Filed: Nov. 12, 2007

(30) Foreign Application Priority Data
Apr. 27, 2007 (CN) 200710200530.0

(51) Int. Cl. G04G 15/00

(52) U.S. Cl. 368/10

(57) ABSTRACT

An electronic device includes an input unit for generating control signals according to operations of a user, a power supply unit for supplying power to the electronic device, a first timer for measuring and signaling the end of a first time interval by outputting a first end signal, a second timer for measuring and signaling the end of a second time interval by outputting a second end signal, a notifier for generating a notice signal based on a notice file, and a controller. The controller is for restarting the first timer and disabling the second timer whenever receiving one of the control signals, restarting the second timer and enabling the notifier when receiving the first end signal, and disabling the power supply unit when receiving the second end signal. A related automatic turnoff method for automatically turning off an electronic device is also disclosed.

### BACKGROUND

1. Field of the Invention

The present invention generally relates to electronic devices and automatic turnoff methods for the electronic devices.

2. Description of Related Art

Electronic devices such as televisions, computers, audio and video players, mobile phones, etc are now very popular and commonly used. People often like to watch television, play computer, or listen to music when they are going to sleep, but it is inconvenient for them to manually turn off the electronic devices, and they may fall asleep without turning them off. When someone leaves a room or building and fails to power off their computers or other electronic devices, the devices may remain on and waste power/energy. Thus, turnoff time may be set in some electronic devices to automatically turn off the electronic devices when a system time reaches the turnoff time. However, it is difficult for users to accurately predict when they will fall asleep or when they will leave.

Therefore, an electronic device and an automatic turnoff method for the electronic device are needed in the industry to address the aforementioned deficiencies and inadequacies.

### SUMMARY

An electronic device includes an input unit, a power supply unit, a first timer, a second timer, a notifier, and a controller. The input unit is for generating control signals according to operations of a user. The power supply unit is for supplying power to the electronic device. The first timer is for measuring and signaling the end of a first time interval by outputting a first end signal. The second timer is for measuring and signaling the end of a second time interval by outputting a second end signal. The notifier is for generating a notice signal based on a notice file. The controller is for restarting the first timer and disabling the second timer whenever receiving one of the control signals, restarting the second timer and enabling the notifier when receiving the first end signal, and disabling the power supply unit when receiving the second end signal. A related automatic turnoff method for automatically turning off an electronic device is also disclosed.

Other systems, methods, features, and advantages of the present electronic device and the present automatic turnoff method will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present electronic device and the present automatic turnoff method can be better understood with reference to following drawings. Components in the drawings are not necessarily to scale, emphasis instead being placed upon clearly illustrating the principles of the present device. Moreover, in the drawings, like reference numerals designate corresponding parts throughout the several views.

FIG. 1 is a schematic diagram showing an electronic device in accordance with a first exemplary embodiment, the electronic device including a display unit.

FIG. 2 is a schematic diagram showing a function menu, for use with the display unit of FIG. 1, showing some icons, the icons include an automatic turnoff icon.

FIG. 3 is a schematic diagram showing a value-setting menu corresponding to the automatic turnoff icon of FIG. 2.

FIG. 4 is a schematic diagram showing an electronic device in accordance with a second exemplary embodiment.

FIG. 5 is a schematic diagram showing a value-setting menu corresponding to the automatic turnoff icon of FIG. 2. in accordance with the second exemplary embodiment.

FIG. 6 is a process flow diagram illustrating an automatic turnoff method in accordance with an exemplary embodiment.

FIG. 7 is a process flow diagram illustrating a setting method of the automatic turnoff method in accordance with an exemplary embodiment.

### DETAILED DESCRIPTION OF THE EMBODIMENTS

Reference will now be made to the drawings to describe a preferred embodiment of the present electronic device and a preferred embodiment of the present automatic turnoff method for automatically turning off the electronic device.

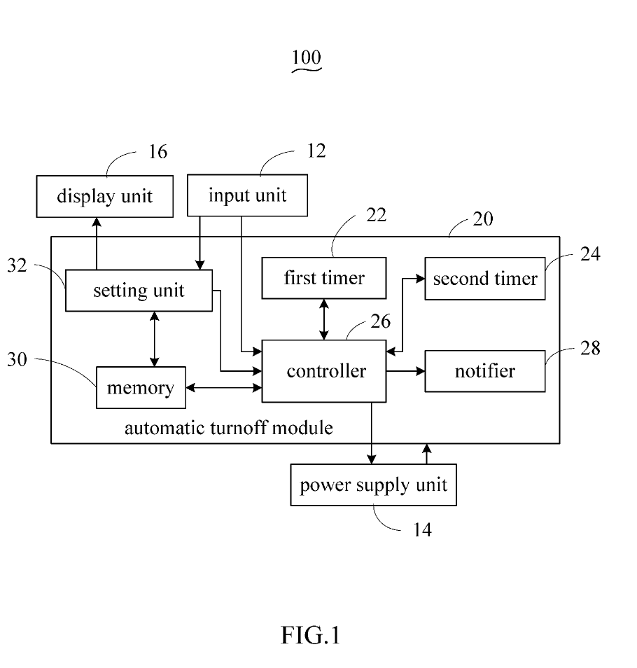

Referring to FIG. 1, an electronic device 100 in accordance with a first exemplary embodiment includes an input unit 12, a power supply unit 14, a display unit 16, and an automatic turnoff module 20.

The electronic device 100 may be a digital television, a computer, an audio and video player, an electronic book, or a digital radiogram, etc. The input unit 12 is used for generating control signals according to operations of a user. The input unit 12 may be a remote controller of the digital television or the audio and video player, or a keyboard of the computer, or a control panel with plural buttons set on the digital television, the audio and video player, the electronic book or the digital radiogram. The user operates the input unit 12 to control the electronic device 100 to perform functions, such as turning on or off, play music or start programs, opening files, modifying dates, etc. If the user does not operate the input unit 12 for an appropriate time interval, it is concluded that the user has finished using the electronic device 100.

The power supply unit 14 is for supplying power to components of the electronic device 100.

The automatic turnoff module 20 includes a first timer 22, a second timer 24, a controller 26, a notifier 28, a memory 30, and a setting unit 32. The first timer 22 is for measuring and signaling the end of a first time interval by outputting a first end signal to the controller 26. The second timer 24 is for measuring and signaling the end of a second time interval by outputting a second end signal to the controller 26. The first time interval and the second time interval are stored in the memory 30. Furthermore, the memory 30 also stores a notice file. The notice file is used by the notifier 28 to notify the user.

The notifier 28 is for generating a notice signal based on the notice file. The notice signal may be an audible signal saying or indicating the query “Are you falling asleep tonight?”, and the notifier 28 may be a speaker (not shown) set in the electronic device 100. Volume of the audible sound should be low enough that a sleeping user is not awakened. The notice signal may be an audible or a visible signal. For example, the notice signal is a cartoon or some other pleasing image with some words asking “Are you falling asleep tonight?” (or only words), and the notifier 28 may be a displayer. If the user is not asleep or not leaving, he may respond via the input unit 12. The input unit generates a response signal, which may be any of the control signals. The response signal can also be a predetermined control signal, and the user may have to follow a direction or directions displayed on the display unit.

The controller 26 is for controlling the first timer 22, the second timer 24, the notifier 28, and the power supply unit 14 according to the control signals. In detail, the controller 26 will restart the first timer 22 and disable the second timer 24 whenever receiving one of the control signals. The controller 26 will restart the second timer 24 and enable the notifier 28 when receiving the first end signal. The controller 26 will disable the power supply unit 14 when receiving the second end signal. When the controller 26 enables the notifier 28, the controller reads the notice file from the memory 30 and sends the notice file to the notifier 28.

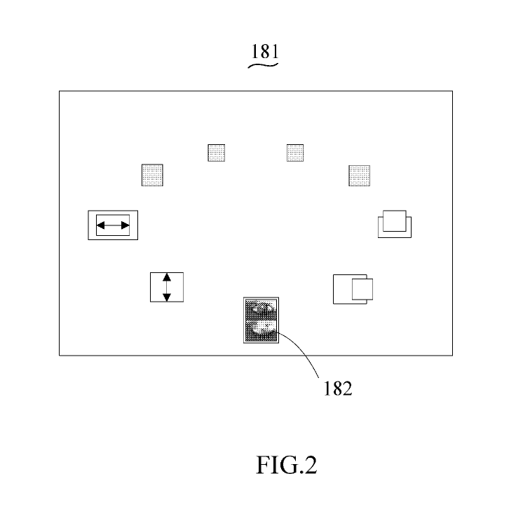

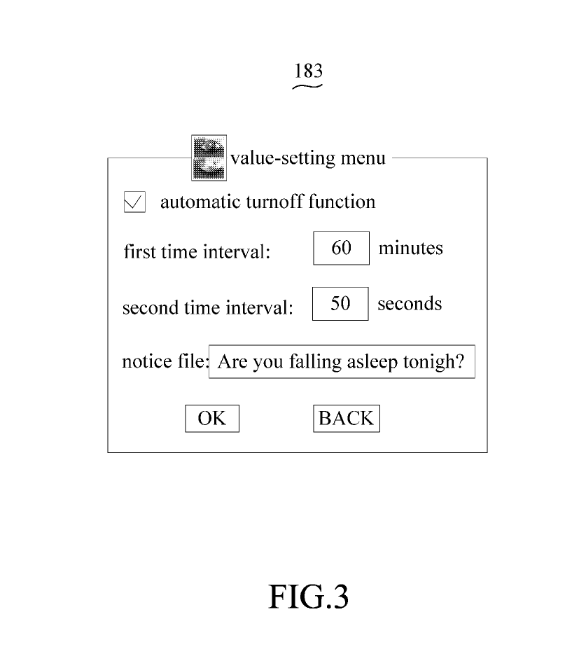

The setting unit 32 is for allowing at least one of the first time interval, the second time interval, and the notice file stored in the memory 30 to be set and modified according to a setting signal received from the input unit 12. The user can set and modify the above parameters using the input unit 12. Referring to FIGS. 2 and 3, a function menu 181 showing some icons such as an automatic turnoff icon 182 is displayed in the display unit 16 according to operations of the user. When the automatic turnoff icon 182 is clicked, a value-setting menu 183 is opened and displayed in the display unit 16.

In the value-setting menu 183, an automatic turnoff function can be selected to enable the controller 26. If the automatic turnoff function is selected, values of the first time interval and the second time interval, and content of the notice file can be set or modified in the value-setting menu 183. If the automatic turnoff function is not selected, the controller 26 is disabled. In the embodiment, the first time interval is set to be 60 minutes, and the second time interval is set to be 50 seconds, and the notice file is set to be “Are you falling asleep tonight?”. There are also two buttons, e.g. OK button and BACK button. If the OK button is clicked, the above-said values and content is stored in the memory 30. If the BACK button is clicked, the values of the first time interval and the second time interval, and content of the notice file retrieve previous values.

When the automatic turnoff function is selected, the controller 26 is enabled and can receive control signals from the input unit 12, and the first timer 22 is started. If there is no control signal received in the first time interval (60 minutes), the first timer 22 outputs the first end signal to the controller 26. The controller 26 then starts the second timer 24, and transmits the notice file (Are you falling asleep tonight?) to the notifier 28. The notifier 28 outputs the notice signal, and the second timer 24 begins to time. If there is no response signal received in the second time interval (50 seconds), the second timer 24 outputs the second end signal, and the controller 26 disables the power supply unit 14. In other words, the electronic device 100 is automatically turned off, and power is saved. If there is a control signal received by the controller 26 during the processes described above, the first timer 22 will be restarted and the second timer 24 will be disabled.

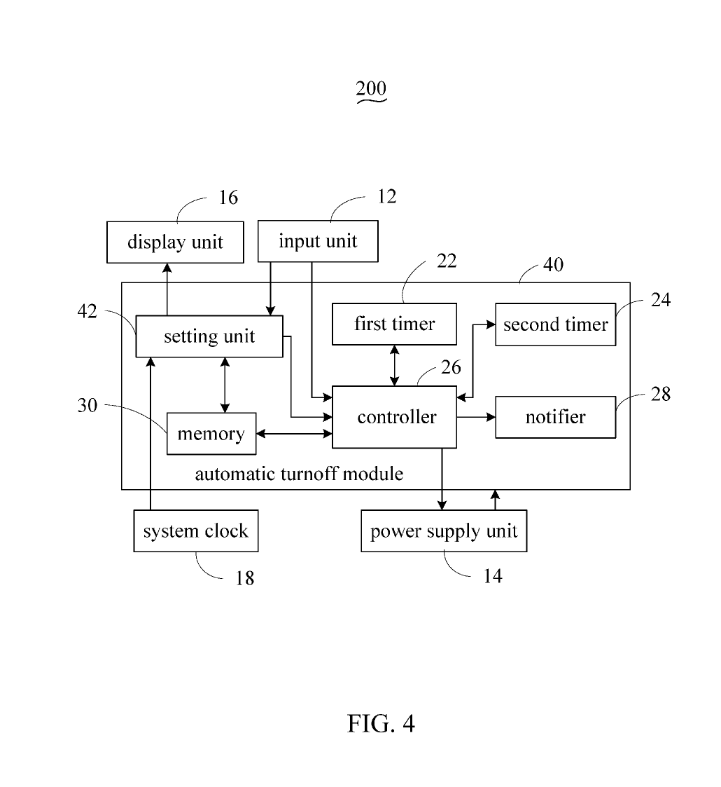

Referring to FIG. 4, an electronic device 200 in accordance with a second exemplary embodiment includes the same input unit 12, the power supply unit 14, and the display unit 16 as the electronic device 100 in the first exemplary embodiment. In the embodiment, the electronic device 200 further includes a system clock 18 for providing a system time, and an automatic turnoff module 40 for automatically turning off the electronic device 200 when it is concluded that a user has finished using the electronic device 100.

The automatic turnoff module 40 includes the same first timer 22, the second timer 24, the controller 26, the notifier 28, and the memory 30 as the electronic device 100 in the first exemplary embodiment. In the embodiment, the automatic turnoff module 40 also includes a setting unit 42, and the memory 30 further stores a predetermined time of the system time. In the following description, we call the predetermined time of the system time a start time.

The setting unit 42 is for allowing at least one of the first time interval, the second time interval, the notice file, and the start time stored in the memory 30 to be set and modified according to a setting signal received via the input unit 12. The setting unit 42 is further used for enabling the controller 26 when the system time of the system clock 18 reaches the start time. That means the controller 26 will be enabled (in other words, the automatic turnoff function is started) only when the system time reaches the start time, such as 11 o'clock at night.

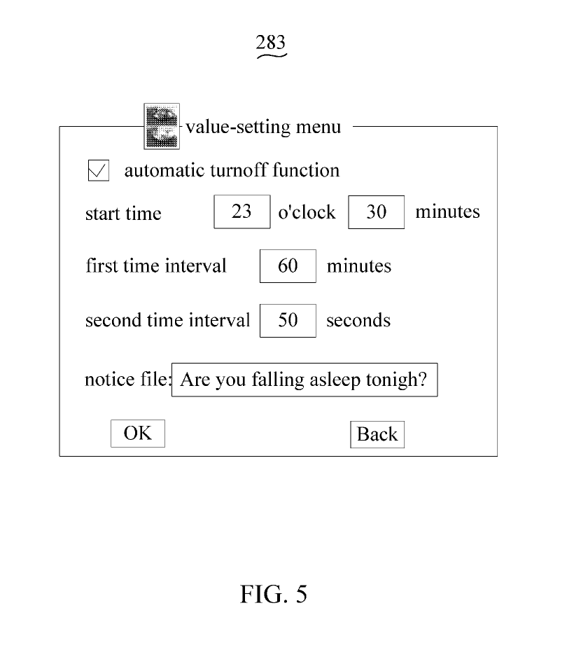

Just like the electronic device 100, the user can set and modify the above said parameters using the input unit 12. Referring to FIGS. 2 and 5, the function menu 181 showing some icons such as the automatic turnoff icon 182 is displayed in the display unit 16 according to operations of the user. When the automatic turnoff icon 182 is clicked, a value-setting menu 283 is opened and displayed in the display unit 16.

In the value-setting menu 283, an automatic turnoff function can be selected to enable the controller 26. If the automatic turnoff function is selected, values of the start time, first time interval and the second time interval, and the content of the notice file can be set or modified in the value-setting menu 283. If the automatic turnoff function is not selected, the controller 26 is disabled. In the embodiment, the start time is set to be 11:30 PM, the first time interval is set to be 60 minutes, and the second time interval is set to be 50 seconds, and the notice file is set to be “Are you falling asleep tonight?”. The same as the first exemplary embodiment, there are an OK button and a BACK button.

In this way, when the automatic turnoff function is selected and the system time of the system clock 18 reaches the start time (11:30 PM), the controller 26 is enabled and can receive control signals from the input unit 12, and the first timer 22 is started. If there is no control signal received in the first time interval (60 minutes), the first timer 22 outputs the first end signal to the controller 26. The controller 26 then starts the second timer 24, and transmits the notice file (Are you falling asleep tonight?) to the notifier 28. The notifier 28 outputs the notice signal, and the second timer 24 begins to time. If there is no response signal received in the second time interval (50 seconds), the second timer 24 outputs the second end signal, and the controller 26 disables the power supply unit 14. In other words, the electronic device 200 is automatically turned off. If there is a control signal received by the controller 26 during the processes described above, the first timer 22 will be restarted and the second timer 24 will be disabled. Because the electronic device 200 can be turned off automatically when it is concluded that the user has finished using the electronic device having fallen asleep or left, power/energy that would otherwise be wasted is saved, and service life of the electronic device 200 is extended.

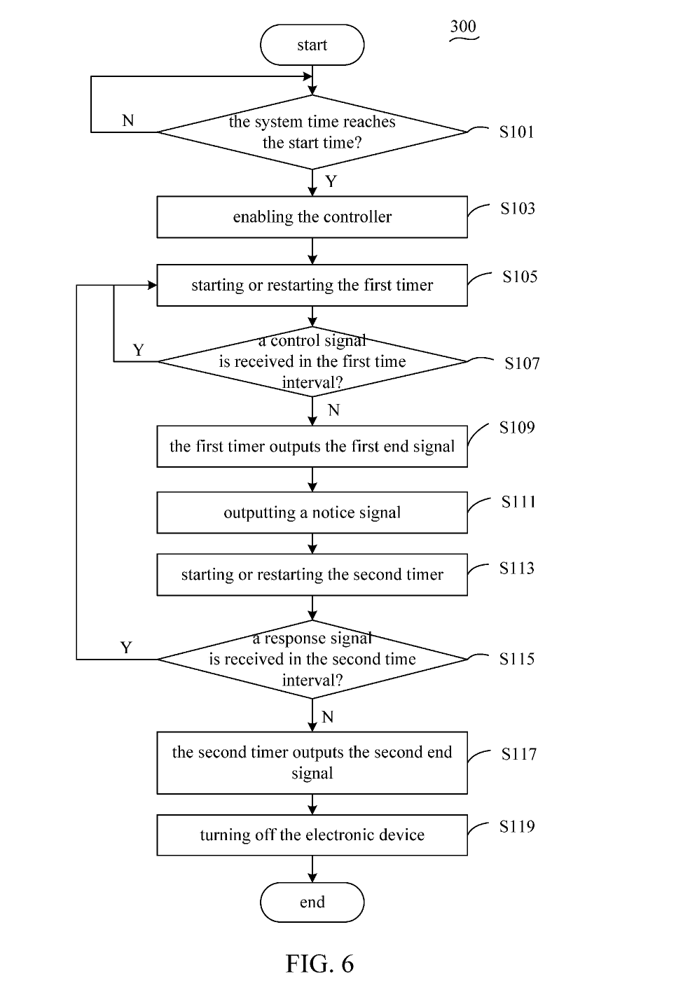

Referring to FIG. 6, a process flow chart 300 for an automatic turnoff method is shown in accordance with an exemplary embodiment. The automatic turnoff method is for automatically turning off the electronic device 200. The automatic turnoff method includes the following steps.

In step S101, the setting unit 42 judges whether the system time of the system clock 18 reaches the predetermined time (the start time). If the system time has reached the start time, go to step S103, or else, repeat step S101.

In step S103, the setting unit 42 enables the controller 26.

In step S105, the controller 26 starts or restarts the first timer 22 to measure and signal the end of the first time interval, and disables the second timer 24.

In step S107, the controller 26 judges whether there is a control signal received in the first time interval, if there is no control signal received, go to step S109, or else, back to step S105.

In step S109, the first timer 22 outputs the first end signal.

In step S111, the notifier 28 outputs a notice signal.

In step S113, the controller 26 starts or restarts the second timer 24 to measure and signal the end of the second time interval.

In step S115, the controller 26 judges whether there is a response signal received in the second time interval, if there is no response signal received, go to step S117, or else, back to step S105.

In step S117, the second timer 24 outputs the second end signal.

In step S119, the controller 26 disable the power supply unit 14, thus, turning off the electronic device 200.

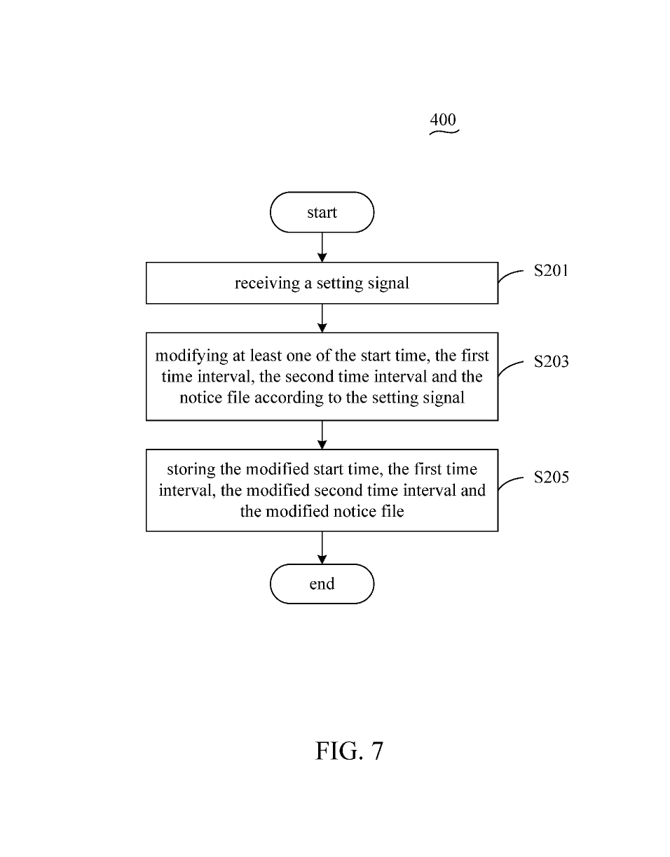

The automatic turnoff method further includes a setting method. Referring to FIG. 7, a process flow chart 400 for the setting method is shown. The setting method includes the following steps.

In step S201, the setting unit 42 receives a setting signal from the input unit 12.

In step S203, the setting unit 42 modifies at least one of the start time, the first time interval, the second time interval, and the notice file according to the setting signal.

In step S205, the memory 30 stores the modified start time, the first time interval, the modified second time interval and the modified notice file.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. An electronic device comprising:
an input unit for generating control signals;
a power supply unit for supplying power to the electronic device;
a first timer for measuring and signaling the end of a first time interval by outputting a first end signal;
a second timer for measuring and signaling the end of a second time interval by outputting a second end signal;
a notifier for generating a notice signal based on a notice file; and
a controller for restarting the first timer and disabling the second timer whenever receiving one of the control signals, restarting the second timer and enabling the notifier when receiving the first end signal, and disabling the power supply unit when receiving the second end signal.

2. The electronic device according to claim 1, further comprising a memory for storing the first time interval, the second time interval, and the notice file.

3. The electronic device according to claim 2, further comprising a setting unit for allowing at least one of the first time interval, the second time interval and the notice file stored in the memory to be set and modified.

4. The electronic device according to claim 1, wherein the notice signal is an audible or a visible signal.

5. The electronic device according to claim 1, further comprising a system clock for signaling a system time, and a setting unit for enabling the controller when the system time reaches a predetermined time.

6. The electronic device according to claim 5, further comprising a memory for storing the predetermined time.

7. The electronic device according to claim 6, wherein the setting unit is further used for allowing the predetermined time stored in the memory to be set and modified.

8. An automatic turnoff method, for automatically turning off an electronic device, comprising:
starting a first timer to measure and signal the end of a first time interval;
judging whether there is a control signal received in the first time interval;
if there is no control signal received, outputting a notice signal;
starting a second timer to measure and signal the end of a second time interval;
judging whether there is a response signal received in the second time interval; and
if there is no response signal received, turning off the electronic device.

9. The automatic turnoff method according to claim 8, further comprising:
restarting the first timer to measure and signal the end of the first time interval if there is a control signal received.

10. The automatic turnoff method according to claim 8, further comprising:
if there is a response signal received, disabling the second timer; and
restarting the first timer to measure and signal the end of the first time interval.

11. The automatic turnoff method according to claim 10, wherein the notice signal is an audible or a visible signal.

12. The automatic turnoff method according to claim 8, further comprising:
receiving a setting signal;
modifying at least one of the first time interval, the second time interval and the notice file according to the setting signal;
storing the modified first time interval, the modified second time interval or the modified notice file.

13. The automatic turnoff method according to claim 8, further comprising:
judging whether a system time reaches a predetermined time;
if the system time reaches the predetermined time, starting the first timer to measure and signal the end of the first time interval.

14. The automatic turnoff method according to claim 13, further comprising:
receiving a setting signal;
modifying the predetermined time according to the setting signal;
storing the modified predetermined time.
